(19) United States
(12) Patent Application Publication
(10) Pub. No.: US 2011/0215612 A1
(43) Pub. Date: Sep. 8, 2011

(54) MOTOR VEHICLE DOOR WITH AN INTERIOR LINING

(75) Inventors: Ralph Maertin, Nieder-Wiesen (DE); Markus Steinbach, Walheim (DE); Holger Thums, Frankfurt (DE); Hendrik Ziegler, Griesheim (DE); Ralf Venino, Hochheim (DE)

(73) Assignee: GM GLOBAL TECHNOLOGY OPERATIONS LLC, Detroit, MI (US)

(21) Appl. No.: 13/041,587

(22) Filed: Mar. 7, 2011

(30) Foreign Application Priority Data
Mar. 5, 2010 (DE) 102010010404.3

(51) Int. Cl. B60J 5/00

(52) U.S. Cl. 296/146.7

(57) ABSTRACT

A motor vehicle door is provided with an interior lining arranged in a panel region of the motor vehicle door. A door framework defines a shaft for accommodating a window that can be raised and lowered relative to the vehicle interior. The door framework accommodates a shaft rail extending into the shaft in the region of its upper end. The interior lining features a fitting rail that overlaps the shaft rail on its upper side and engages behind the shaft rail on the shaft side. The fitting rail features a fitting web that covers the door framework on its outer side referred to the vehicle. The fitting web penetrates into a depression formed by the shaft rail and interlocks with the shaft rail at this location.

### CROSS-REFERENCE TO RELATED APPLICATION

This application claims priority to German Patent Application No. 102010010404.3, filed Mar. 5, 2010, which is incorporated herein by reference in its entirety.

### TECHNICAL FIELD

The technical field relates to a motor vehicle door with an interior lining that is arranged in a panel region of the door.

### BACKGROUND

An interior door lining is typically mounted on the framework of a motor vehicle door by fitting the interior door lining into the framework of the door and interlocking the interior door lining in its fitted position.

DE 10 2007 007 457 A1 describes a motor vehicle door with an interior lining that is arranged in a panel region of the door. A door framework defines a shaft for accommodating a window that can be raised and lowered relative to the vehicle interior and the door framework accommodates a shaft rail in the region of its upper end. This shaft rail extends into the shaft. The interior lining features a fitting rail that overlaps the shaft rail on its upper side and engages behind the shaft rail on the shaft side. This engagement behind the shaft rail is realized relatively short and, referred to its vertical extent, does not cover the upper end of the door framework, but rather only the shaft rail in its region that is arranged above the door framework. On the side of the vehicle interior, the fitting rail furthermore features a relatively long rib with an extension that is arranged in the region of its lower end and engages underneath the shaft rail.

In order to mount the interior door lining, it is therefore required to pivot the upper end of the interior door lining about the shaft rail in order to reach the locking mechanism underneath the shaft rail.

In view of the foregoing, it is at least one objective to ensure that, in a motor vehicle door with an interior lining arranged in a panel region of the door, the interior lining is effectively prevented from separating when pulling the door shut in this region. At least another objective is to provide a simple mounting of the interior lining on the door framework. This mounting can furthermore be realized in an uncomplicated fashion. Yet another objective is to provide a mounting of the interior lining on the door framework that meets the requirements of a side impact. In addition, other objectives, desirable features and characteristics will become apparent from the subsequent summary and detailed description, and the appended claims, taken in conjunction with the accompanying drawings and this background.

### SUMMARY

A motor vehicle door with an interior lining The fitting rail provided on the interior lining, which is also referred to as cliprail, overlaps the shaft rail on its upper side and engages into the shaft rail on the shaft side. The fitting rail features a fitting web that covers the door framework on its outer side referred to the vehicle. The fitting web penetrates into a depression formed by the shaft rail and interlocks with the shaft rail in the depression. This depression is realized, in particular, in the form of a shaft.

The fitting rail therefore covers the door framework with its fitting web on the exterior of the vehicle and the fitting web penetrates into the depression formed by the shaft rail and interlocks therein. The interlocking may take place over the entire length of the fitting rail, only locally or in the form of a combination thereof in order to purposefully realize reinforcement measures. It is no longer necessary to utilize clips or the like because this function is now fulfilled by the shaft rail profile that is typically preinstalled on a sheet metal flange of the door framework.

Due to the design of the fitting rail with the fitting web and the design of the shaft rail with the depression, the interior lining can be fitted in the form of a simple linear movement that essentially takes place, in particular, in the Z-direction, i.e., the vertical direction. A pivoting movement or kinematically much more complicated movement of the interior lining to be fitted into the door framework is no longer required for the installation of the interior lining. The essentially linear movement during the installation of the interior lining according to the invention broadens the freedom of design and simplifies the installation of components that are installed together with the motor vehicle door such as, for example, an interior safety button. In comparison with a pivoted installation of the interior lining, the linear installation furthermore provides the advantage that Bowden wires and cables utilized in the region of the interior door lining only need to follow a linear movement.

The fitting bracket may by all means form part of the lining substrate of the interior lining because the door framework, particularly the sheet metal flange of the door framework, absorbs pull-off forces in the direction of the vehicle center such that it may, under certain circumstances, not be necessary to utilize high-strength materials for the manufacture of the fitting rail. Due to the upwardly directed extension of the shaft rail that forms the depression of the shaft rail on the window side, costly bending of a panel lamination is not required because the trimmed edge of the laminating material, which is frequently uneven after the laminating process, is covered by the extension that is realized, in particular, in the form of a sealing lip in the region of its upper end such that a clean line is achieved on the exterior. Since the fitting web is arranged relatively close to the window and therefore positioned relatively far outward, it is possible to utilize a tool with a relatively simple design for producing the panel lamination.

The shaft rail may be realized, in particular, in the form of a sealing profile for contacting the window. It may also be provided with a reinforcement in order to ensure the sealing function relative to the window on the other hand and the respective holding function of the shaft rail and the door framework or the shaft rail and the fitting rail on the other hand.

The fitting rail preferably comprises plastic. This fitting rail and a substrate for the lamination of the interior lining are realized, in particular, in one piece. According to one additional development, the fitting rail features a projection that contacts the shaft rail on its inner side referred to the vehicle. Consequently, the fitting rail is not only positioned relative to the shaft rail in the region of the fitting web, but also in the region of the projection of the fitting rail.

The motor vehicle door with the interior lining arranged in the panel region of the door therefore can also meet the requirements of a side impact and allows a simple, solid, advantageous and uncomplicated mounting of the interior door lining in the panel region of the motor vehicle door. Due to the special arrangement of the door framework, the shaft rail and the fitting rail, the inventive design also ensures the reliable mounting of the interior door lining with respect to the fact that the motor vehicle door is exposed to different thermal effects—low temperatures in winter and high temperatures in summer.

### BRIEF DESCRIPTION OF THE DRAWINGS

The present invention will hereinafter be described in conjunction with the following drawing figures, wherein like numerals denote like elements, and:

FIG. 1 shows a motor vehicle door with interior lining before the fitting of the positioned interior lining and after the fitting of the interior lining in the interesting connecting region between interior lining and door framework, namely in the form of a cross section referred to the longitudinal direction of the vehicle.

### DETAILED DESCRIPTION

The following detailed description is merely exemplary in nature and is not intended to limit application and uses. Furthermore, there is no intention to be bound by any theory presented in the preceding background or summary or the following detailed description.

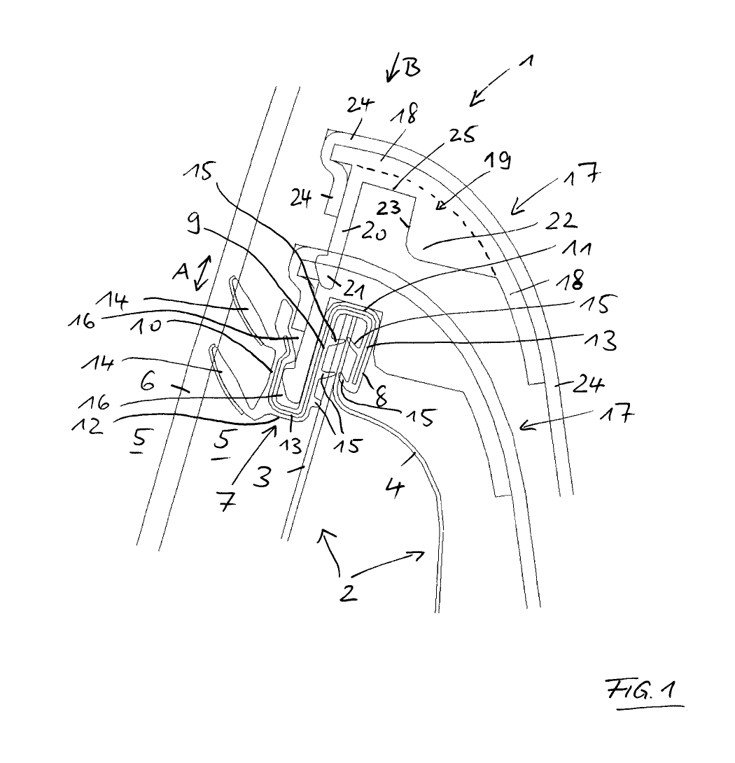

FIG. 1 shows a section through the region of a passenger car door, for example a driver's door of a passenger car as it is, in principle, described in the exemplary embodiment of DE 10 2007 007 457 A1. The motor vehicle door 1 is illustrated in its panel region, i.e., the region situated adjacent to the lower end of the window opening of the vehicle door 1. The vehicle door 1 features a door framework 2 that has sheet metal and is composed of a shaft sheet 3 and in inner sheet 4 that adjoin one another and are welded together in the region of their upper end. Toward the vehicle interior, the shaft sheet 3 defines a shaft 5 for accommodating a window 6 that is essentially arranged vertically and can be raised and lowered in the direction of the double arrow A in order to open and close the window, wherein the window 6 is completely lowered into the shaft 5 in the opened position. A shaft sheet that defines the shaft 5 toward the exterior of the vehicle is not illustrated.

A shaft rail 7 that essentially extends over the entire length of the window opening is attached onto the upper end of the door framework 2, namely at a location, at which the shaft sheet 3 and the inner sheet 4 are connected to one another. The shaft rail 7 is realized in the form of a sealing profile for contacting the window 6. The shaft rail 7 is realized in a multi-angled fashion. It features an inner section 8, a center section 9 and an outer section 10 that are essentially arranged parallel to one another. An upper web 11 connects the inner section and the center section 9 to one another and a lower web 12 connects the center section 9 and the outer section 10 to one another. The shaft rail 7 is provided with a thin metallic reinforcement 13 in the region of the sections 8 to 10 and the webs 11, 12. Two elastic sealing lips 14 that contact the window 6 are connected to the elastic outer section 10 of the shaft rail 7.

On their sides that face one another, the inner section 8 and the center section 9 of the shaft rail 7 are provided with ribs 15 that adjoin and clamp the door framework 2 between one another in the upper region thereof such that the shaft rail 7 attached to the door framework 2 is securely positioned in the door framework 2. In the region of the inner section 8 and the center section 9, the shaft rail 7 therefore is positioned laterally of the door framework 2 referred to the upper region thereof and the shaft rail 7 adjoins the upper face of the door framework 2 with its upper web 11.

The center section 9, the outer section 10 and the interconnecting web 12 of the shaft rail 7 form a depression 16 of the shaft rail 7 that consequently is realized in the form of a shaft, but referred to as depression below in order to prevent confusions with the above-defined shaft 5. This shaft 5 extends almost up to the level of the upper end of the door framework 2.

An interior lining 17 to be installed in the panel region of the vehicle door 1 features a plate-shaped substrate 18 of plastic that accommodates a fitting rail 19 or cliprail in its bottom region. The substrate 18 and the fitting rail 19 form one component, wherein the substrate 18 is distinguished from the fitting rail 19 by means of a broken line in the figure. In the region of its end that faces the window 6, the fitting rail 19 features a fitting web 20 that is realized straight and provided with a snap-in tab 21 in the region of its lower end. Toward the vehicle interior, the fitting rail 19 features a projection 22 that is spaced apart from the fitting web 20 and forms a section 23 arranged parallel to the fitting web 20 such that a receptacle opening is formed between the section 23 and the fitting web 20.

The interior lining 17 features a lamination 24 that laminates the substrate 18 and is realized in the form of a multiple bend with an angle of approximately 90° in the region of the end that faces the window 6, namely such that the free end of the lamination 24 facing the window 6 is also connected to the fitting web 20 approximately in the region of the upper third of the fitting web 20.

In FIG. 1, the upper illustration shows the interior lining 17 in its position before the fitting into the door framework 2 while the lower illustration shows the interior lining 17 in the fitted position. The upper illustration of the interior lining 17 elucidates that the fitting web 20 is positioned in longitudinal alignment with the depression 16 such that it is merely required to move the interior lining 17 from the upper position into the lower fitted position in the direction of the arrow B. During the fitting of the interior lining 17 into the door framework 2, the fitting web 20 is inserted into the depression 16 and the fitting rail 19 is attached onto the shaft rail 7, wherein the fitting web 20 contacts the center section 9 of the shaft rail 7 and the section 23 of the fitting rail 19 contacts the inner section 8 of the shaft rail 7, and the region 25 of the fitting rail 19 formed between the fitting web 20 and the section 23 adjoins the upper web 11 of the shaft rail 7. In this fitted position of the interior lining 17, the snap-in tab 21 of the fitting web 20 engages behind an undercut in the outer section 10 of the shaft rail 7 such that the fitting web 20 and the shaft rail 7 interlock at this location and an unintentional separation of the interior lining 17 in the sense of a movement opposite to the arrow B is precluded.

The fitting rail 19 therefore overlaps the shaft rail 7 on the upper side in the region 25 and engages behind the shaft rail 7 with the fitting web 20 on the shaft side. The fitting web 20 that extends below the connecting region between the shaft sheet 3 and the inner sheet 4 and therefore covers the door framework 2 on its outer side referred to the vehicle penetrates into the depression 16 formed by the shaft rail 7 and interlocks with the shaft rail 7 at this location.

The fitting web 20 and the shaft rail 7 are interlocked over the entire length or a section of the fitting rail 19. When the interior lining 17 is fitted, the lamination 24 partially protrudes into the depression 16 and is overlapped at this location by the upper free end of the outer section 10 of the shaft rail 7. The interior lining 17 is fitted into the door framework 2 in a moving direction B that essentially extends parallel to the arrangement of the window 6 or parallel to the moving direction A of the window 6, respectively.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle door, comprising:
a panel region;
an interior lining arranged in the panel region; and
a door framework defining a shaft and configured to accommodate a window that is movable between a raised and a lowered position relative to the vehicle interior and the door framework accommodates a shaft rail extending into the shaft in the region of an upper end,
wherein the interior lining comprises a fitting rail that overlaps the shaft rail on an upper side and engages behind the shaft rail on the shaft side,
wherein the fitting rail comprises a fitting web that covers the door framework on an outer side, and
wherein the fitting web penetrates into a depression formed by the shaft rail and interlocks with the shaft rail.

2. The motor vehicle door according to claim 1, wherein the fitting web is provided with a snap-in tab that engages into an undercut of the depression.

3. The motor vehicle door according to claim 1, wherein the fitting web features the snap-in tab in the region of a downwardly directed end.

4. The motor vehicle door according to claim 1, wherein the fitting web and the shaft rail are interlocked over a substantially entire length of the fitting rail.

5. The motor vehicle door according to claim 1, wherein the fitting web and the shaft rail are interlocked over a substantially entire section of the fitting rail.

6. The motor vehicle door according to claim 1,
wherein the interior lining comprises a substrate and a lamination for the substrate, and
wherein the fitting rail forms part of the substrate.

7. The motor vehicle door according to claim 1, wherein a lamination of the interior lining partially covers the fitting web and is inserted into the depression of the shaft rail.

8. The motor vehicle door according to claim 1, wherein the shaft rail is a sealing profile that adjoins the window.

9. The motor vehicle door according to claim 1, wherein the fitting rail comprises plastic.

10. The motor vehicle door according to claim 1, wherein the depression of the shaft rail and the fitting web are arranged such that the fitting rail is moved linearly in order to fit the fitting rail into the shaft rail.

11. The motor vehicle door according to claim 10, wherein the is moved particularly parallel to the window in order to fit the fitting rail into the shaft rail.

12. The motor vehicle door according to claim 1, wherein the fitting rail comprises a projection that contacts the shaft rail on an inner side referred to the vehicle.
